(19) United States
(12) Patent Application Publication
(10) Pub. No.: US 2006/0037223 A1
(43) Pub. Date: Feb. 23, 2006

(54) System, apparatus and method for storing and transporting memorabilia

(76) Inventor: Jeanne-marie Ciriacks, West Bend, WI (US)

Correspondence Address: JOHN K. MCCORMICK, 6781 GLACIER DRIVE, WEST BEND, WI, 53090, US

(21) Appl. No.: 10/711,033

(22) Filed: Aug. 18, 2004

(51) Int. Cl. G09F 19/00

(52) U.S. Cl. 40/537

(57) ABSTRACT

The present invention discloses adhesive labels, adhesive rod loops, a stand, a memorabilia holder, a carrying case and a system for easily storing and accessing both flat and three dimensional items, such as memorabilia, cards, stickers, lettering and/or other items, in a transparent memorabilia holder wherein the memorabilia holders can be easily placed in the disclosed stand for semi-permanent storage, or selected memorabilia holders removed and placed in the disclosed carrying case for ease of transportation to and from specified locations. The stand allows for a plurality of memorabilia holders to be placed onto rods protruding from the top of the stand. The stand is rotatable so that a user can have quick and easy access to any of the items in the memorabilia holders by simply rotating the base or top of the stand to the desired position. In the alternative, the memorabilia holders attached to the rods can be swung back and forth to find the desired memorabilia holder within a section of the stand. Optionally, the stand can have a flexible or hard cover to protect the items stored in the memorabilia holders from dust and damage. In addition, if the optional hard cover is utilized, the hard cover has a handle on the top that allows for the transportation of the entire stand and its contents to and from various locations. The memorabilia holders are transparent and have a wide variety of pouches, in both size and shape, formed into the memorabilia holder. The memorabilia holder has holes on the inner edge of the memorabilia holder for loading and storing the memorabilia holders in a ring binder arrangement. The memorabilia holders also have a rod loop at the top of the memorabilia holder for placing the memorabilia holder onto the rods in the top of the stand or on the rods in the carrying case for transportation. The memorabilia holders also have optional label tags on either the top or right side of the memorabilia holders for identifying the contents of a specific memorabilia holder. The carrying case is designed to hold and contain a plurality of memorabilia holders through the use of the rods in the spine of the carrying case or with the ring clips, along with other items. The carrying case can be closed and sealed shut or it can be opened up and stood on its base with the use of a third rigid leg that rotates out to hold the carrying case in an upright position such that the memorabilia holders located on the rods can be easily accessed. The disclosed adhesive label tags and adhesive rod loops are for use on existing memorabilia holders that do not have labels or rod loops in order to convert the existing memorabilia holders for use in both the disclosed stand and in the disclosed carrying case. The system disclosed is for the loading of items into the memorabilia holders and then loading the memorabilia holders into the stand at a semi-permanent location. When the user so chooses, selected memorabilia holders can be easily removed from the stand and placed into the carrying case for transport to and from a specific event without having to transport all memorabilia holders.

### BACKGROUND ART

There has developed within the Arts and Crafts industry a growth industry called scrapbooking. Scrapbooking began around 1987 in or around the state of Utah and has been spreading outward from that point. In 2003, the sales of scrapbooking supplies had climbed to roughly $3 billion annually. Scrapbooking is an activity wherein an individual acquires an album similar to a blank paper page photo album. The individual then proceeds to create an artful pictorial and verbal historical record, complete with photographs, decorative descriptive wording, artistic stickers and all kinds of other embellishments that essentially trace significant moments or periods of an individuals life from birth onward in a fun, pleasing and artful manner. For most scrapbookers (those who practice scrapbooking), an album is created for each of their children, presumably to be passed onto their children at some later date.

Traditionally, scrapbooking has been dominated by females and the process of scrapbooking was done mostly in small groups at one of the group member's homes or some other suitable location. While each scrapbooker worked on their own scrapbook project, they could share time, ideas, creative insights, supplies, current events discussions and whatever else they wanted to share. It is both a social event and a planned activity to work on their craft of scrapbooking.

In order to do scrapbooking, a lot of equipment and supplies are required. There are scissors, knives, a wide variety of pens and writing utensils, adhesives, wide varieties of paper, measuring devices, protective placements, stacks of photographs or other personal items such as drawings, buttons, used tickets from events and, of necessity, a very wide assortment of stickers. These stickers come in a very wide assortment of sizes, shapes, colors and themes. The stickers are used to enhance the pictures or verbiage added to the scrapbook page that is being worked upon. For example, there are a variety of stickers for birthdays, Halloween, the 4^{th} of July, Memorial Day, Valentines Day, and any other recognized special day. In addition to this there are hundreds of stickers that are available for any suitable use. Stickers of rainbows, airplanes, flowers, ships or what ever else you can think of are available. In order to store the stickers, people have developed and used a clear flat plastic sheet, hereinafter referred to as a storage sheet, with a variety of different shaped pouches molded into them that are closable and sealable to prevent the enclosed items from falling out unnecessarily. These storage sheets are generally 12 inches by 12 inches, although there are other sizes, and there are three holes punched into one edge for storage in a standard three ring binder.

When an individual gets into scrapbooking, they generally start with a set of basic equipment and supplies, including a folder or bag designed to be mobile and to carry a limited amount of supplies and equipment. The folder is designed to hold and carry a limited number of the plastic 12 inch by 12 inch storage sheets that contain the stickers. However, as the individual continues with their scrapbooking activity, the type and variety of stickers and other supplies they need keep increasing. There are more and more sticker varieties as well as other supplies. Since the bag capacity is limited, the scrapbooker is generally forced into purchasing larger and larger carrying cases in order to transport all of their supplies and equipment to someone else's home or other suitable location for a scrapbooking meeting, even though the scrapbooker will only use a small portion of the supplies and equipment they are taking to the scrapbooking meeting. This becomes a significant logistics concern and weight problem to all serious scrapbookers sooner or later.

In addition to this problem, the actual scrapbooking meeting causes another logistics problem with the scrapbook meeting. When a group of scrapbookers meet to work on their scrapbook, a large amount of table or work space is required for each scrapbooker. Each scrapbooker needs sufficient space for the album they are working on including their stickers, equipment and the photographs they have brought along for the meeting. Since each person is working on their own specific page in the scrapbook, the majority of an individual's space requirement is large and unshareable. For example, when an individual opens up their binder carrying the supplies and stickers, it occupies a space of 12 inches by 24 inches. To this space requirement must be added the space for the album page they are working on, the room for equipment such as pens, adhesives, pictures, scissors, and so forth. As most homes are not equipped with readily available table or work space to handle this type of infrequent meeting and work space requirements, it becomes a struggle for most scrapbookers to effectively and productively meet and socialize while they participate in their hobby of scrapbooking.

In addition to this, a newer trend has been emerging in the field of scrapbooking. More and more scrapbookers have begun to create permanent spaces within their home dedicated to their hobby of scrapbooking. It is currently estimated that 30% of the scrapbookers have now created or are creating a dedicated area within their homes focused solely on the hobby of scrapbooking. They are reallocating available space within their dwellings to accommodate their new needs. This has created a new set of problems and concerns. These individuals want to have a dedicated area to work on their scrapbooking hobby on their own, and they still want to be able to be mobile and go to other scrapbooker's homes to work in group activities. Thus the technical problem arises as to how best to organize all of their stickers and the equipment and supplies that they need in a comfortable yet compact permanent setting and still allow for the stickers, equipment and supplies to be made easily selectively mobile when they travel to a scrapbooking meeting at another scrapbooking location.

### DESCRIPTION OF DRAWINGS

For a further understanding of the nature and objects of the invention, reference should be made to the following description and appended claims, taken in conjunction with the accompanying drawings, in which like elements are given the same reference numbers. It is to be understood that these drawings depict only typical embodiments of the invention and are, therefore, not to be construed as limiting the scope and spirit of the invention.

FIG. 1 depicts the stand with sample memorabilia holders loaded onto some of the stand rods.

FIG. 2 depicts the stand showing the rods in both a vertical and a horizontal position.

FIG. 3 depicts a rigid base and cover for the stand.

FIG. 4 depicts a flexible cover for the stand.

FIG. 5 depicts a sample memorabilia holder with a plurality of pouches, the rod loop and the label tag.

FIG. 6 depicts an end view of an adhesive rod loop.

FIG. 7 depicts an end view of an adhesive label tag.

FIG. 8 and FIG. 9 depict existing memorabilia holder with the attached adhesive rod loops and adhesive label tags.

FIG. 10 depicts the carrying case in an upright position.

### BEST MODE

Detailed embodiments of the present invention are disclosed herein as illustrated in the drawings; however it is to be understood that the disclosed embodiments are merely exemplary of the invention, which may be embodied in various forms. In addition, although the invention is described and explained by the use of examples from the Arts and Crafts industry, and specifically the scrapbooking craft, there is no intent to limit the invention to the examples used or to the embodiment or embodiments disclosed therein. On the contrary, the intent is to include all alternatives, modifications and equivalents included within the scope and spirit of the inventions as defined by the appended claims.

The spirit of the invention is to solve the aforementioned problems by providing a system, apparatus and a method or means for both storing and using items at a permanent location, such as at individual's home or other locale, and a means for selecting specific groups of stored items and transferring said items to a carrying case for transport to an outside event, such as a group scrapbooking event, without having to bring all of the other available items and supplies with them.

As a general overview, the system includes a mechanical device for storing said items and/or memorabilia in a permanent location, called the stand, another mechanical device that is a flat and rectangular carrying case for use in the transportation of scrapbooking supplies and memorabilia, called the carrying case, and a set of item and/or memorabilia holders, called a memorabilia holder, for placing said items and/or memorabilia into for either storage in the stand or into the carrying case for transport. In addition, an apparatus and a system are provided to convert existing memorabilia holders for use with the new stand and new carrying case and for providing an apparatus and a means for applying label tags to existing memorabilia holders. A variety of stand and memorabilia covers are also provided to protect, cover and secure the contents of the stand and in one exemplary mode to allow for the stand and its entire contents to be contained for transportation purposes.

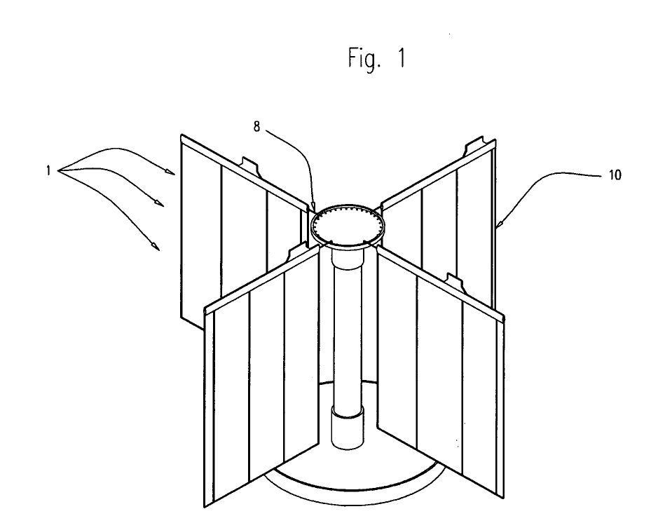

FIG. 1, depicts the overall use of the stand 1 with a plurality of memorabilia holders 10 positioned on a plurality of rods 8. In use, the user (not shown) can rotate the base of the stand 1, like a lazy-susan, in order to position a specific memorabilia holder 10, that they desire access to, in front of them. In addition, the rods 8 in the stand 1 swing such that a group of memorabilia holders 10 in front of a user (not shown) can flip through a group of memorabilia holders 10 to find the specific memorabilia holder 10 they desire without rotating the entire stand 1. The stand 1 is vertical, cylindrical in shape and rotates at the base, however other shapes are available that would accomplish the same ends and are not to be excluded in the specification of this invention. The memorabilia holders 10 are held in their general location in the stand by the use of the pivotal rods 8. By rotating the base of the stand and/or pivoting the memorabilia holders on the pivotal rods, all of the contents of the memorabilia sheets can be viewed and the different contents selected from the memorabilia holder.

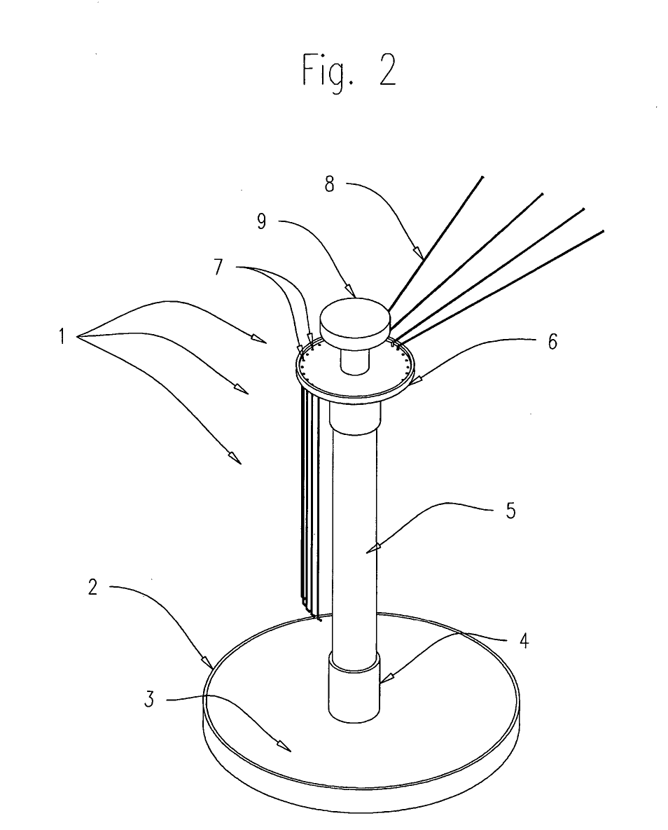

FIG. 2 depicts the stand 1 without any of the memorabilia holders 10. The stand 1 consists of a base 2, a rotatable base plate 3, a base support flange 4, a main center post 5, and an upper support flange 6. The rotatable base plate 3 is fixed to the base support flange 4 which is fixed to the center post 5. The upper support flange 6 is fixed to the center post 5. The upper support flange 6 has a plurality of holes 7 designed to accept the holder rods 8. When in use, the holder rods 8 are pulled up through the holes 7 and placed in a horizontal position to accept a memorabilia holder 10 (not shown). The rods 8 can swing or pivot in their holes 7 when in use. When the rods 8 are not in use they can be slid back into the holes 7 to hang in a vertical position near the main center post 5.

Attached to the upper support flange 6 is an optional handle 9. The user (not shown) can either rotate the stand 1 to the desired position by either gripping the handle 9 and turning the stand 1 or by turning the stand 1 using the rotatable base plate 3.

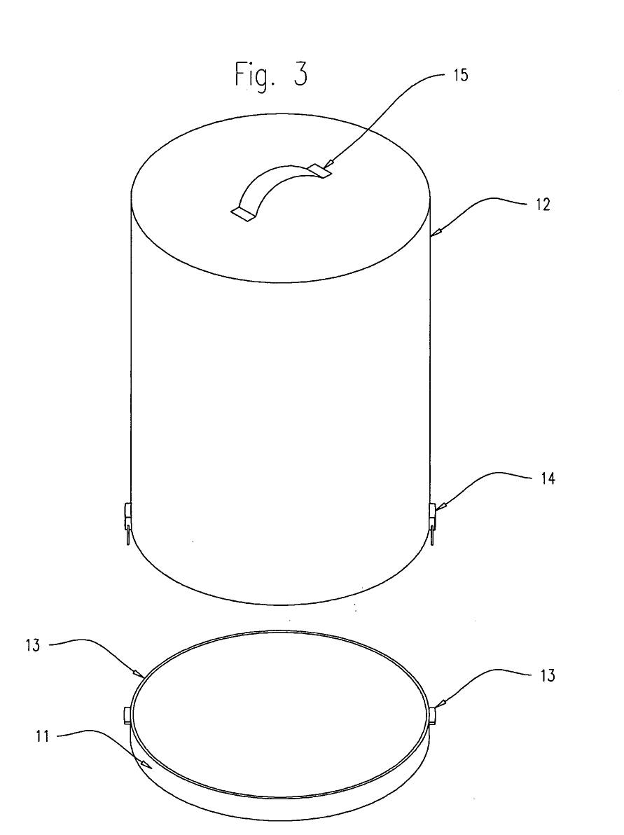

FIG. 3 depicts a hard cover 12 and hard lower base 11 for storing the stand 1 and memorabilia holders 10 (not shown). The hard lower base 11 is constructed so as to receive the base 2 of the stand 1 (not shown) in a secure position. The hard lower base 11 has a plurality of clips 13 attached to the hard lower base 11. The hard cover 12 has a handle 15 attached to the top of the hard cover 12 and a plurality of latches 14 attached to the hard cover 12 in such a manner as to secure the hard cover 12 to the hard lower base 11 by the use of the latches 14 and the clips 13 for transportation and/or cleanliness and security. Other means of securing a hard cover 12 to a lower base 11 are well know and practiced in the art.

In the alternative, the hard cover could be provided without the said hard lower base, said clips and said latches to act as just a protective cover, with or without the said handle. In addition, the exterior of the hard cover and/or the hard lower base could come in a wide variety of colors, patterns, materials and/or textures to provide an esthetically pleasing exterior.

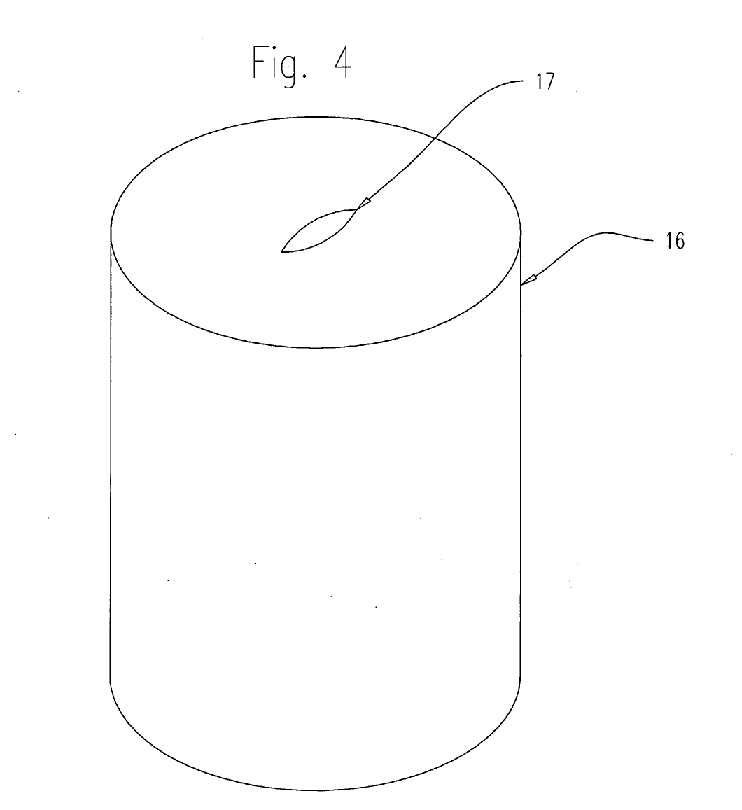

FIG. 4 depicts a flexible cover 16 for the stand 1 and memorabilia holders 10 (not shown). If the stand 1 has the optional handle 9 on the top of the upper support flange 6 (not shown), then a slot 17 in the flexible cover 16 would be available to accept the optional stand handle 9. The flexible cover 16 could be made of any desired plastic, cloth or other flexible material and come in a variety of colors or patterns (not shown) to create a pleasing and esthetic view or to match a users decorating style.

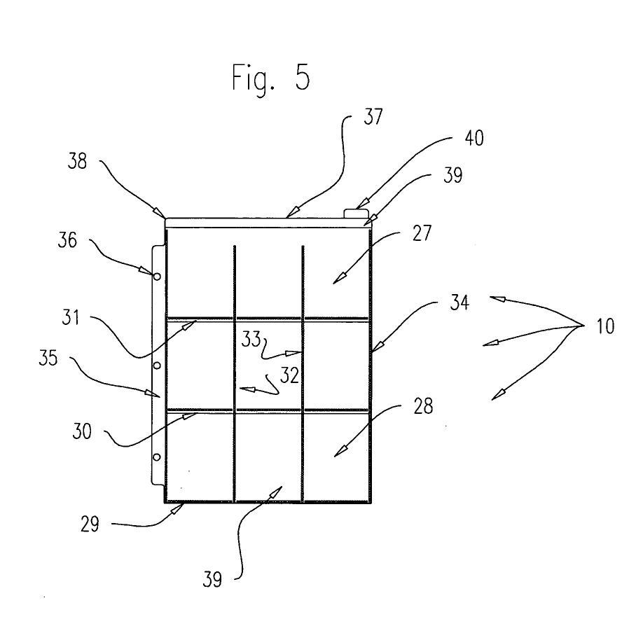

FIG. 5 shows one example of a memorabilia holder 10 having a plurality of pockets 27. The memorabilia holder 10 could have a single large pocket 27 or any number of pockets 27 in a wide variety of shapes and sizes. Today, each pocket 27 is meant to hold flat pieces of paper stickers that are used in the scrapbooking activity. As such, each pocket 27 is rather thin and flat. In addition to the existing flat holding sheets, the new memorabilia holder 10 improves upon this existing holding sheet by providing for the containment for three dimensional objects within the memorabilia holder 10. The new development can include expanding pockets 27, or ballooning pockets, that allow the user to place within the pocket 27 an object that is not flat, such as buttons, yarn, shells, writing pens and other mementoes that have depth as well as width and length to them. The flat pockets and the ballooning pockets 27 can have a cover flap (not shown) that can be used to secure the contents into the pouch during travel or use. The closing mechanism for the pockets 27 could be flaps, snaps, zippers or any other appropriate means for sealing the pocket 27 to prevent any items from coming out of the pockets 27 unnecessarily. This allows for the systematic storage and carrying of a much wider variety of items that could be used in the existing scrapbooking memorabilia holders. The size of both the flat and the ballooning style pockets 27 vary a lot in order to accommodate a wide variety of memorabilia shapes. For example, there could be only three pockets 27 running vertically up the entire length of the memorabilia holder 10, or there could be four pockets 27 of equal size on the memorabilia holder 10 or any number of other configurations. Each pocket 27 has a transparent front wall 28 and back wall 39. The top of each pocket 27 is open on one side of the sheet so as to receive any items (not shown) placed within the pocket 27. Any tough transparent material, such as polyethylene, polyvinylchloride, polyester, polypropylene and/or other transparent material could be utilized for the back wall 39 and the pockets 27. Optionally, the back wall 39 need not be transparent.

The sheets or plies of material are bonded or sealed together along a series of sealing lines 29, 30, 31, 32, 33, 34 and 35. The sealing lines are preferably formed by heat, RF ultra sound or the like so that the two faces are fused together at their point of contact with sufficient strength to define the retaining pockets 27. Other means of forming the bonding lines, such as gluing the materials together, may also be employed.

Each memorabilia holder 10 also has a horizontal loop 37 running the length of the top of the memorabilia holder 10. The horizontal loop 37 is open at both ends 38 and 39 that allows for the memorabilia holder to be easily placed and/or removed from the rods 8 shown in FIG. 1. The memorabilia holder 10 also has an optional label tag holder 40 that is shown attached to the horizontal loop 37. The label tag holder 40 could be positioned anywhere along the top or right outside edge of the memorabilia holder 10. The label tag holders 40 can be made to either hold a written label or be written upon in order to indicate the general contents of the memorabilia holder pockets 27. This enables a user to quickly identify and locate the desired memorabilia (not shown) within the plurality of memorabilia holders 10.

In its preferred embodiment, there is a plurality of holes 36 on the left edge of the memorabilia holder 10 such that the memorabilia holder 10 and its contents (not shown) can be secured in a book, such as a ring binder, post binder or similar device.

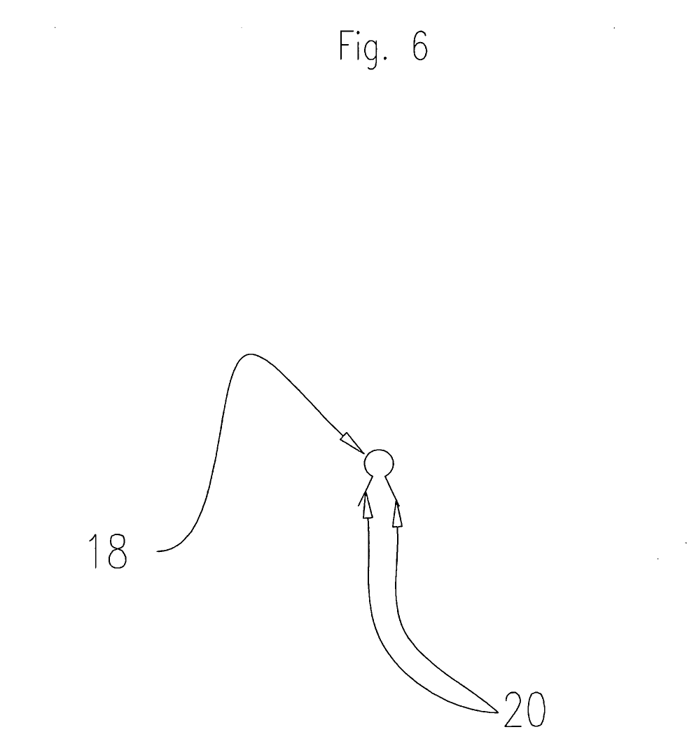

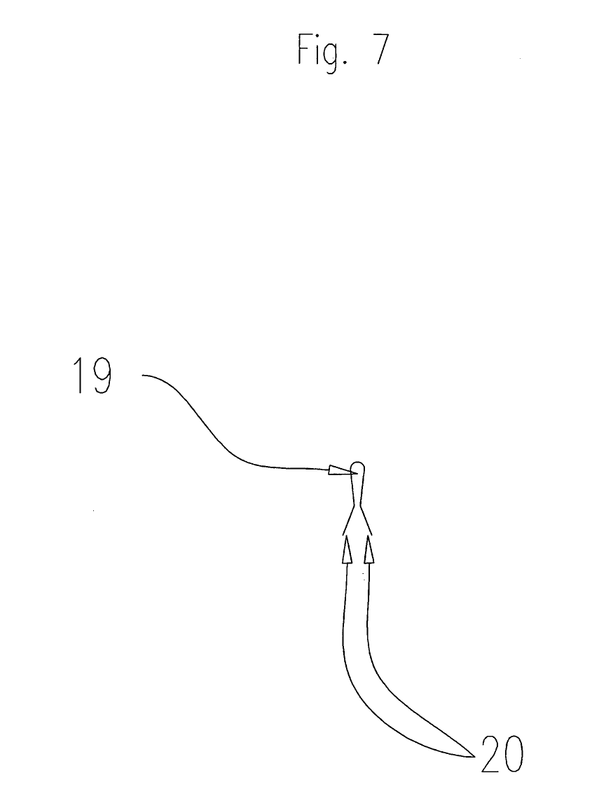

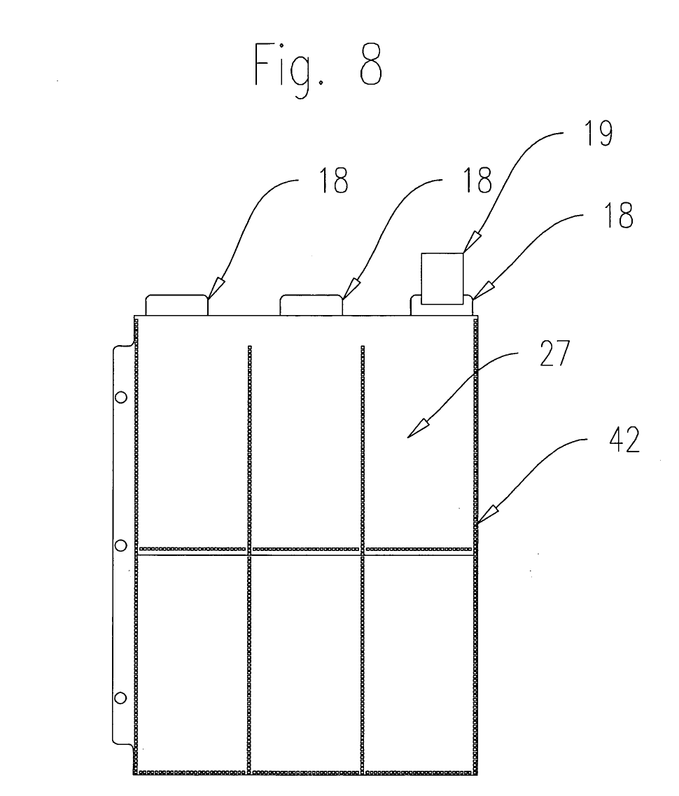

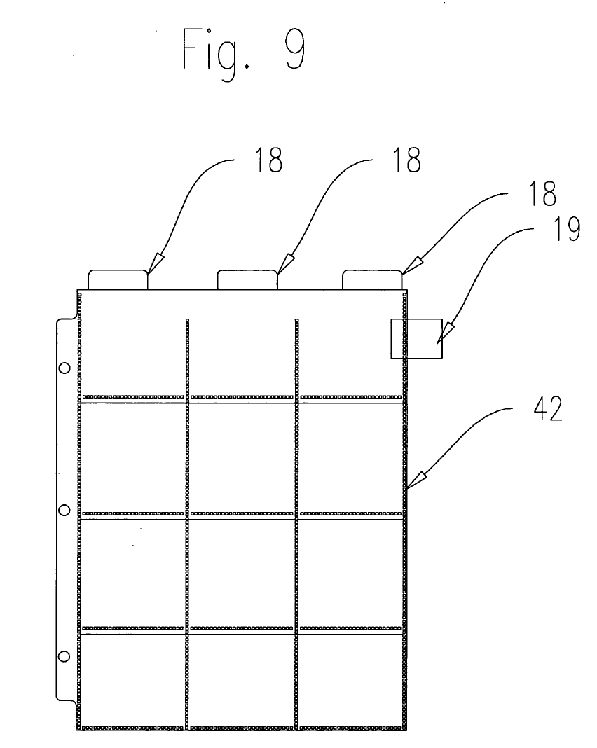

FIG. 6 depicts an end view of an adhesive 20 attachable rod loop 18 that can be applied to existing memorabilia holders (not shown) that do not have the built-in horizontal loop 37 on the top of the memorabilia holder 10 shown in FIG. 5. FIG. 7 depicts an end view of an adhesive 20 attachable label tag holder 19 that can be applied to existing memorabilia holders (not shown) that do not have the built-in label tag holder on the top and/or side of the memorabilia holder 10 shown in FIG. 5. FIG. 8 depicts an existing memorabilia holder 42 with a plurality of rod loops 18 attached to the top of the existing memorabilia holder 42 without sealing the top pockets 27. Also shown in FIG. 8 is the label tag holder 19 attached to one of the rod loops 18. FIG. 9 depicts an existing memorabilia holder 42 with a plurality of rod loops 18 attached to the top of the existing memorabilia holder 42 and a label tag holder attached to the right side edge of the existing memorabilia holder 42.

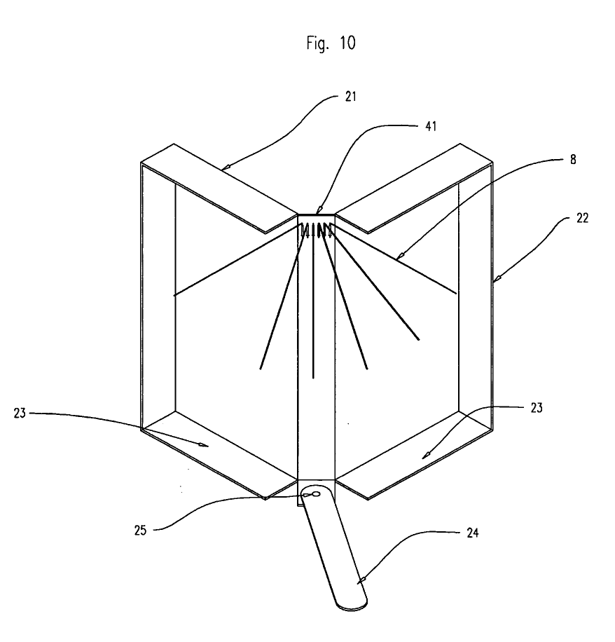

FIG. 10 depicts a carrying case 21 or binder for storing memorabilia holders 10 or 42 (not shown) for transportation to and from a scrapbooking event. The carrying case 21 is closable through the use of a zipper 22, clasps, straps or other sealing mechanisms. The carrying case has a spine 41 with an optional handle and/or carrying strap (not shown). Inserted movably and/or pivotally into the spine 41 are rods 8 for holding the memorabilia holders (not shown). The rods 8 in the spine 41 can swing in a back and forth motion. In the alternative, the spine 41 could also contain a plurality of rings (not shown) for securing the memorabilia holders into the carrying case 21. The spine 41 and the base 23 of the carrying case 21 can be relatively stiff. The base 23 of the carrying case could also contain a stiff leg 24 that is movably attached to the base of the spine 41 at a pivot point 25. The optional stiff base 23 of the carrying case 21 and the attached leg 24 allow the carrying case to be opened and set upright on a table or other surface such that all of the memorabilia holders (not shown) in the carrying case 21 are available for use.

In a semi-permanent location, the user would place objects such as cards, stickers, letter, buttons, or other memorabilia into the pockets 27 in the memorabilia holders 10 and/or 42. The user would then load the memorabilia holders 10 and/or 42 onto the rods 8 in the stand 1. When scrapbooking, a user could remove the cover 12 or 16 and rotate the stand 1 and/or swing the rods 8 in order to find and position the memorabilia holders 10 and/or 42 they desired in order to access some specific memorabilia. The label tag holders 40 and/or 19 allow the user to label their memorabilia holders 10 and/or 42 for quick and easy identification and selection. When the user was finished working on their scrapbooking project, they could replace the cover 12 or 16 to keep dirt, dust and prying fingers away from the memorabilia. Depending upon the chosen pattern or color of the cover 12 or 16, the enclosed stand 10 presents a neat, secure and esthetic view.

When a user desires to attend an offsite scrapbooking event, the user has two options. If the user has the stand 1 with the optional hard lower base 11 and the hard cover 12 with the handle 15, they can simple close and latch the hard cover 12 to the hard lower base 11 and transport it to the scrapbooking site in whole. Once at the scrapbooking site, the user can simple remove the hard case 12 and begin scrapbooking. The same method of sealing up the stand 1 applies when the user is finished scrapbooking and desires to return home.

In the alternative, if the user has the carrying case 21 they can simply slide the memorabilia holders 10 and/or 42 they want to take with them off the rods 8 on the stand 1 and place those memorabilia holders 10 and/or 42 onto the rods 8 in the carrying case 21. In the alternative, the use could secure the memorabilia holders 10 and/or 42 into the ring binder clips (not shown). The user then closes the carrying case 21 and transports it to the scrapbooking site. Once at the scrapbooking site, the user can open up the carrying case 21 and by spreading out the base 23 of the carrying case 21 and the movable leg 24, position the binder upright in order to have access to the enclosed memorabilia holders 10 and/or 42. Alternatively, the user could simply slide the memorabilia holders (not shown) off of the rods 8 in the carry case 21, place the carrying case 21 out of the way, and access only the memorabilia they desire at that time.

The new method for scrapbooking consists of creating a permanent location stand 1 for holding scrapbooking memorabilia, creating a memorabilia holder 10 and/or 42 that allows for the easy addition or removal of memorabilia holders 10 and/or 42 to and from the permanent stand 1 and to and from the carrying case 21. This permits the scrapbooker to easily and quickly convert their scrapbooking activity from a permanent location activity to a mobile one as the scrapbooker only needs to take with them those memorabilia holders 10 and/or 42 that contain the memorabilia supplies that they need for the period of time they are going to be offsite scrapbooking.

There are many other uses for this invention other than for scrapbooking. This invention could be used to display a multitude of items for sale or for decorative purposes. A person could display sports cards, hand-made holiday cards, stamps, paint chips, wood samples, cabinetry hardware, medical supplies, and a host of other objects. The improvement would be in the easy and quick display of items, the easy and quick access to the items, the transport and mobility of the items, and the small amount of ‘foot space’ the storage device requires given the amount of viewable storage space it has to offer. For scrapbooking, scrapbookers could work from the same stand as they can all hang their memorabilia holders 10 and/or 42 on one stand 1, rotate the unit to the memorabilia they wish to access, and share supplies.

I claim:

### Mode for Invention

The invention relates to an apparatus, system and means for storing a variety of items in memorabilia holders in such a way as to allow for the memorabilia holders, and the items stored therein, to be kept in a semi-permanent rotatable stand for ease of access and use, and for selected memorabilia holders to be easily removed and placed in a carrying case for efficient and secure transportation to and from specified offsite events. The invention also provides a means for converting existing memorabilia holders for use in the disclosed stand and carrying case.

The memorabilia holder is made of a transparent material and has a wide variety of shapes and sizes to the pouches on the memorabilia holder that contain and confine the memorabilia stored in the pouches. The memorabilia holder also has optional holes on one edge for placement into a ring or post type binder. The memorabilia holders also have rod loops on the top of the holder for storing the memorabilia holders in either the stand or the carrying case. Additionally, the memorabilia holders can have label tags on the top or outside edge for identifying the general contents of the memorabilia holders.

The stand consists of a rotatable base, a central post and a plurality of rods attached to the top of the stand. The rods can be placed horizontally to accept the rod loops attached to the memorabilia holders in order to hold the memorabilia holders in a pivotal vertical position, or the rods can be lifted up and slid down the hole, next to the central post, in the stand top in order to store the unused rods out of the way. The stand can optionally have a hard cover for protecting the stand and its contents or a hard lower base and hard cover, with a handle, for securely sealing the stand and contents through the use of clips or other securing mechanisms such that the stand and its contents are protected and/or can be transported. Optionally, the stand can have a flexible cover that is used to protect the contents of the stand from dirt or prying fingers. Both the hard and flexible cover can come in a wide variety of colors, textures, materials and/or decorative patterns to create an esthetically looking artifact.

The carrying case has a plurality of rods pivotally secured in the upper spine of the carrying case for accepting the rod loops on the memorabilia holders. Optionally, the carrying case can also contain ring clips for securing memorabilia holders to the ring clips. The base of the carrying case can be of stiff material and the base can have a movable stiff third leg built into the carrying case. If the carrying case has the stiff base and third movable leg, when the carrying case is opened up, the rotatable leg can be positioned outward such that the two stiff bases of the opened carrying case and the movable stiff third leg provide a three legged base to position and support the carrying case in an upright position such that there is easy access to the contents of the carrying case and to the memorabilia holders. The carrying case can also have a variety of built in pouches and pockets to hold a variety of items. The cover of the carrying case can come in a wide variety of colors, textures, materials and/or patterns to be esthetically pleasing to the user.

The adhesive rod loops and the adhesive label tags provide a means for users to convert existing memorabilia holders for use in the disclosed stand and carrying case. The adhesive label tags can be used independently of the stand and the carrying case if the user so desires.

1. A stand for organizing and storing memorabilia for display and access, wherein said stand includes:
a. a base;
b. a rotatable base plate;
c. a center post connected to said base plate;
d. an upper support flange connected to said center post;
e. a plurality of rods slideably and pivotally positioned in a plurality of holes in the periphery of the said upper support flange; and
f. a memorabilia holder for holding a plurality of memorabilia comprising:
i. a back that is preferably transparent;
ii. a rod loop at the top of the said memorabilia holder for accepting said rod; and
iii. a plurality of pouches mounted to the said back, each of said pouches comprising:
1. a transparent front wall,
2. a bottom; and
3. first and second side edges.

2. A stand according to claim 1 [c1], wherein the said stand is further characterized by having a protrusion fixedly attached to the top of the said upper support flange for rotating the said stand and/or for lifting and moving the said stand.

3. A stand as in any one of the preceding claims [c1][c2], wherein the said stand includes a hard case comprising:
a. a hard cover;
b. said hard cover being available in a variety of colors, textures, materials and/or patterns.

4. A hard cover as in claim 3 [c3], wherein the said hard cover further includes:
a. a handle on the top of the said hard case;
b. a hard lower base for accepting the said stand; and
c. a means for securing the said hard cover to the said hard lower base.

5. A stand as in any one of claims 1 through 4 [c1][c2][c3][c4], wherein said stand includes:
a. a flexible covering; and
b. said flexible covering being available in a variety of colors, textures, materials and/or patterns.

6. A flexible covering as in claim 5 [c5], wherein said flexible covering includes having a slot in the top of the said flexible covering to accept the said protrusion on the top of the said upper support flange.

7. A memorabilia holder as in any one of claims 1 through 6 [c1][c2][c3][c4][c5][c6], wherein said memorabilia holder pouches are expandable in order to contain three dimensional objects.

8. The memorabilia holder as in any one of claims 1 through 7 [c1][c2][c3][c4][c5][c6][c7], wherein said memorabilia holder has a means for holding said memorabilia holder in a ring binder.

9. The memorabilia holder as in any one of claims 1 through 8 [c1][c2][c3][c4][c5][c6][c7][c8], wherein the said pouches have a means for closing and securing the top of the said pouches in order to prevent any of the stored contents from falling out of the said pouches.

10. The memorabilia holder as in any one of claims 1 through 9 [c1][c2][c3][c4][c5][c6][c7][c8][c9], wherein the said memorabilia holder has a label tag attached to an outside edge of the said memorabilia holder(s).

11. A carrying case comprising:
a. generally rectangular front and back covers;
b. a stiff spine to the said carrying case;
c. a plurality of rods rotatably attached to the top inside of the said spine that accept the memorabilia holders with the rod loops attached; and
d. a means for sealing the said front and back covers of the said carrying case.

12. The carrying case of claim 11 [c11], wherein said carrying case includes ring binder clips.

13. The carrying case as in any one of claims 11 through 12 [c11][c12], wherein said carrying case includes additional pouches attached to the inside of the said carrying case for storing additional items.

14. The carrying case as in any one of claims 11 through 13 [c11][c12][c13], wherein said carrying case exterior is of a variety of textures, materials, colors and/or patterns to present a safe, secure and esthetic appearance.

15. The carrying case as in any one of claims 11 through 14 [c11][c12][c13][c14], wherein said carrying case includes:
a. a stiff base to the bottom of the said front and back covers;
b. a stiff third leg moveably attached to the base of the said spine; and
c. a means for positioning the said stiff bases of the said front and back covers and the said stiff third leg such that the said carrying case can be opened and positioned upright for access to the said carrying case's contents.

16. The carrying case as in any one of claims 11 through 15 [c11][c12][c13][c14][c15], wherein said carrying case includes an external handle and/or strap attached to the said spine.

17. Separate rod loop(s) for attachment to existing memorabilia holders that do not have the rod loop.

18. A separate label tag for attachment to existing memorabilia holders so that individual memorabilia holders can have their contents generally identified by the said protruding separate label tags.

19. A method for storing and accessing memorabilia and other items such that the stored memorabilia are available for access in a stored semi-permanent location and so that specific sheets of memorabilia or other items are available for easy removal and placement within a carrying case for secure transportation to and from a remote location wherein:
a. the steps of storing and accessing the memorabilia in the semi-permanent location comprises the steps of:
i. loading a variety of memorabilia or other items into a plurality pouches in a plurality of memorabilia holders;
ii. sliding the rod loop on the top of a said memorabilia holder onto a slideable and pivotally attached rod, said rod attached to a memorabilia stand;
iii. rotating the top and/or base of the said memorabilia stand to the desired said memorabilia holder and/or swinging the said memorabilia holders and said rods pivotally in the stand to find the said memorabilia holder desired;
iv. accessing the said memorabilia in the said memorabilia holder; and
b. the steps of transporting and accessing selected said memorabilia holders to and from a remote location using a carrying case comprising the steps of:
i. rotating the said memorabilia stand to the desired location;
ii. swinging the said memorabilia holders on the pivotable rods and selecting the desired said memorabilia holder;
iii. sliding the said memorabilia holder off of the said rod on the said memorabilia stand;
iv. opening up the said carrying case with rods moveably attached to the spine of the said carrying case;
v. sliding the said rod loop on the top of the said memorabilia holder onto the said rod in the said carrying case;
vi. repeating steps i through v above until all of the desired said memorabilia holders are stored in the said carrying case;
vii. closing and sealing the said carrying case;
viii. transporting the said carrying case with the enclosed said memorabilia holders to and from the said remote location; and
ix. accessing the said memorabilia holders by opening the said carrying case and turning the said memorabilia holders to the desired said memorabilia holder sheet and/or removing the said memorabilia from the said pouches or removing the said memorabilia holder from the said carrying case.

20. The method as in claim 19 [c19] wherein the steps of storing and accessing selected said memorabilia holders further includes:
a. placing a hard cover over the said stand with said attached memorabilia holders; and
b. removing the hard cover when a user desires to access the memorabilia holders.

21. The method as in claim 20 [c20] wherein the steps of storing, accessing and transporting selected said memorabilia holders further includes:
a. placing the said stand on a lower hard base;
b. placing the said hard cover over the said stand and onto the said lower hard base;
c. securing the said hard cover to the said hard cover base;
d. lifting the said hard cover, said attached hard cover base and said enclosed stand by a handle on the top of the said hard cover and transporting it to a remote location;
e. removing the said hard cover from the said hard cover base;
f. accessing the said memorabilia and said memorabilia holders on the said stand by swinging the said memorabilia holders on the said rods and/or by rotating the said memorabilia stand; and
g. placing the said hard cover over the said stand with said attached memorabilia holders and securing the said hard cover to the said hard cover base and lifting and transporting the said hard cover, said attached hard cover base, said enclosed stand and said memorabilia holder(s) by a handle on the top of the said hard cover back to the original location.

22. The method as in any one of claims 19 through 21 [c19][c20][c21] wherein the said steps of storing and accessing the said memorabilia include attaching label tags to the said memorabilia holders for ease of identifying the contents of the said memorabilia holders.

23. The method of any one of claims 19 through 22 [c19][c20][c21][c22], wherein said memorabilia holder(s) pouches are expandable in order to accept three dimensional objects.

24. The method of any one of claims 19 through 23 [c19][c20][c21][c22][c23], wherein said memorabilia holder has a means for holding said memorabilia holder in a ring and/or post type binder.

25. The method of any one of claims 19 through 24 [c19][c20][c21][c22][c23][c24], wherein the said pouches have a means for closing and securing the top of the said pouches in order to prevent any of the stored contents from falling out of the said pouches.

26. The method of any one of claims 19 through 25 [c19][c20][c21][c22][c23][c24][c25], wherein the said steps of storing and accessing the said memorabilia include the steps of taking existing memorabilia holder(s) that lack the said rod loop and attaching a separate rod loop or loops to the top of the said existing memorabilia holder for sliding onto the said rods.

27. The method of claim 26 [c26] wherein the said steps of storing and accessing the said memorabilia include:
a. taking said existing memorabilia holder(s) and attaching a separate label tag to the said existing memorabilia holder(s); and
b. labeling the said label tags.

28. The method of any one of claims 19 through 27 [c19][c20][c21][c22][c23][c24][c25][c26][c27] that includes:
a. placing and removing a hard cover over the said stand when desired; and
b. said hard cover being available in a variety of colors, textures, materials and/or patterns.

29. The method of any one of claims 19 through 27 [c19][c20][c21][c22][c23][c24][c25][c26][c27] that includes:
a. placing the said stand onto a hard lower base;
b. placing a hard cover over the said stand and onto the said hard lower base, said hard cover having a handle on the top of the said hard cover;
c. a means for securing and unsecuring the said hard cover to the said lower base;
d. transporting the said hard cover, said hard lower base, said stand and said memorabilia holders to and from a remote location from a semi-permanent location;
e. unsecuring and removing the said hard cover when desired.

30. The method of any one of claims 19 through 29 [c19][c20][c21][c22][c23][c24][c25][c26][c27][c28][c29] that includes:
a. placing and removing a flexible cover over the said stand when desired; and
b. said flexible cover being available in a variety of colors, materials, patterns and/or textures.

31. The method of claim 30[c30] that includes a slot on the said flexible cover for accepting a protrusion on the top of the said stand.

32. A system and means for storing and accessing memorabilia and other items such that the stored memorabilia are available for access in a semi-permanent location and so that specific categories of memorabilia are available for easy removal and placement within a carrying case for secure transportation to and from a remote location, wherein said system comprises:
a. a stand, said stand comprising:
i. a base;
ii. a rotatable base plate;
iii. a center post connected to said base plate;
iv. an upper support flange connected to said center post;
v. a plurality of rods slideably and pivotally attached to a plurality of holes in the periphery of the said upper support flange; and
b. a memorabilia holder for holding a plurality of memorabilia comprising:
i. a transparent back;
ii. a rod loop at the top of the said memorabilia holder for accepting a rod; and
iii. a plurality of pouches mounted to the said back, each of said pouches comprising:
1. a transparent front wall,
2. a bottom;
3. first and second side edges; and
c. a carrying case comprising:
i. generally rectangular front and back covers;
ii. a stiff spine to the said carrying case;
iii. a plurality of rods rotatably and pivotally attached to the top inside of the said spine that accept the memorabilia holders with the rod loops attached;
iv. a means for sealing the said front and back covers of the said carrying case; and
d. wherein said system includes:
i. a means for storing and accessing the memorabilia in the semi-permanent location comprises the steps of:
1. loading a variety of memorabilia and/or other items into a plurality of said pouches in a plurality of said memorabilia holders;
2. sliding the said rod loop on the top of the said memorabilia holder(s) onto a said rod(s) attached horizontally to the said memorabilia stand;
3. rotating the said top and/or base of the said memorabilia stand to the desired said memorabilia holder and/or pivoting the said memorabilia holders in a group of said memorabilia holders to locate the desired said memorabilia holder;
4. accessing the said memorabilia in the said memorabilia holder; and
ii. the means for transporting and accessing selected said memorabilia holders to and from a remote locate comprising the steps of:
1. rotating the said memorabilia stand and/or swinging the said memorabilia holders to the desired location;
2. finding and selecting the desired said memorabilia holder;
3. sliding the said memorabilia holder off of the said rod on the said memorabilia stand;
4. opening up the said carrying case with rods moveably attached to the spine of the said carrying case;
5. sliding the said rod loop on the top of the said memorabilia holder onto the said rod in the said carrying case;
6. repeating steps 1 through 5 above until all of the desired said memorabilia holders are stored in the said carrying case;
7. closing and sealing the said carrying case;
8. transporting the said carrying case with the enclosed said memorabilia holders to and from the said remote location; and
9. accessing the said memorabilia holders by opening the said carrying case and pivoting the said memorabilia holders to the desired said memorabilia holder and/or removing the said memorabilia from the said pouches or removing the said memorabilia holder from the said carrying case.

33. The stand according to claim 32 [c32], wherein the said stand includes a protrusion fixedly attached to the top of the said upper support flange for rotating the said stand and/or for moving the said stand.

34. The stand according to any one of claims 32 through 33 [c32][c33], wherein the said stand includes a hard cover comprising:
a. a hard cover for covering the said stand when desired; and
b. said hard cover being available in a variety of colors, textures, materials and/or patterns.

35. The hard cover according to claim 34 [c34], wherein;
a. the said stand is placed upon a lower hard base;
b. the said hard cover is placed over the said stand and onto the said base;
c. a means for securing and unsecuring the said hard cover to the said hard lower base, with the said stand and said memorabilia holder(s) contained within the said lower hard base and said hard cover;
d. transporting the said hard case, hard lower base, said stand and said memorabilia holders to and from a remote location through the means of a handle fixedly attached on the top of the said hard case; and
e. accessing said memorabilia holders and said stand by unsecuring and removing the said hard case when desired.

36. The stand as in any one of claims 32 through 35 [c32][c33][c34][c35], wherein said stand includes:
a. a flexible covering; and
b. said flexible covering being available in a variety of colors, textures, materials and/or patterns.

37. The flexible cover as in claim 36 [c36], wherein said flexible cover includes having a slot in the top of the said flexible covering to accept a protrusion on the top of the said stand.

38. A memorabilia holder as in any one of claims 32 through 37 [c32][c33][c34][c35][c36][c37], wherein said memorabilia holder pouches are expandable in order to contain three dimensional objects.

39. The memorabilia holder as in any one of claims 32 through 38 [32][c33][c34][c35][c36][c37][c38], wherein said memorabilia holder has a means for holding said memorabilia holder in a ring binder.

40. The memorabilia holder as in any one of claims 32 through 39 [c32][c33][c34][c35][c36][c37][c38][c39], wherein the said pouches have a means for closing and securing the top of the said pouches in order to prevent any of the stored contents from falling out of the said pouches.

41. The memorabilia holder as in any one of claims 32 through 40 [c32][c33][c34][c35][c36][c37][c38][c39][c40], wherein the said memorabilia holder has a label tag attached to either he top or the outside edge of the said memorabilia holder.

42. The carrying case as in any one of claims 32 through 41 [c32][c33][c34][c35][c36][c37][c38][c39][c40][c41], wherein said carrying case includes ring binder clips.

43. The carrying case as in any one of claims 32 through 42 [c32][c33][c34][c35][c36][c37][c38][c39][c40][c41][c42], wherein said carrying case further includes additional pouches attached to the inside of the said carrying case for storing additional items.

44. The carrying case as in any one of claims 32 through 43 [c32][c33][c34][c35][c36][c37][c38][c39][c40][c41][c42][c43][c44], wherein said carrying case further includes a means, such as a handle and/or strap for carrying the said carrying case.

45. The carrying case as in any one of claims 32 through 44 [c32][c33][c34][c35][c36][c37][c38][c39][c40][c41][c42][c43][c44], wherein said carrying case exterior can be of a variety of textures, materials, colors and/or patterns to present an esthetic appearance.

46. The carrying case as in any one of claims 32 through 45 [c32][c33][c34][c35][c36][c37][c38][c39][C40][c41][c42][c43][c44][c45], wherein said carrying case further includes:
a. a stiff base to the bottom of the said front and back covers;
b. a stiff third leg moveably attached to the base of the said spine; and
c. a means for positioning the said stiff bases of the said front and back covers and the said stiff third leg such that the said carrying case can be opened and positioned upright for access to the said carrying case's contents.

47. The memorabilia holders as in any one of claims 32 through 46 [c32][c33][c34][c35][c36][c37][c38][c39][c40][c41][c42][c43][c44][c45][c46], wherein the said memorabilia holders are of the existing type or art that do not have the rod loops and wherein there is a separate attachable rod loop that is attached to the said existing memorabilia holders such that the said existing memorabilia holders are usable with the said stand and said carrying case.

48. The memorabilia holders as in any one of claims 32 through 47 [c32][c33][c34][c35][c36][c37][c38][c39][c40][c41][c42][c43][c44][c45][c46][c47], wherein the said memorabilia holders are of the existing type or art that do not have the label tags and wherein there is a separate attachable label tag that is attached to the said existing memorabilia holders for identifying the general contents of the said memorabilia holders.
